(19) United States
(12) Patent Application Publication
(10) Pub. No.: US 2018/0145420 A1
(43) Pub. Date: May 24, 2018

(54) WIDEBAND ANTENNA RADIATING ELEMENT AND METHOD FOR PRODUCING WIDEBAND ANTENNA RADIATING ELEMENT

(71) Applicant: NEC Corporation, Minato-ku, Tokyo (JP)

(72) Inventor: Taras KUSHTA, Tokyo (JP)

(73) Assignee: NEC Corporation, Minato-ku, Tokyo (JP)

(21) Appl. No.: 15/572,247

(22) PCT Filed: May 28, 2015
(86) PCT No.: PCT/JP2015/002701

§ 371 Date: Nov. 7, 2017

(51) Int. Cl. H01Q 15/00; H01Q 1/52; H01Q 5/335; H01Q 1/42; H01Q 9/28

(52) U.S. Cl. CPC H01Q 15/0086; H01Q 1/523; H01Q 5/335; H01Q 5/20; H01Q 1/422; H01Q 9/28; H01Q 15/0026

(57) ABSTRACT

It is an object of the present invention to provide compact and wideband antenna radiating elements based on multilayer substrate technologies which can be applied in lightweight radars. A wideband antenna radiating element disposed in a multilayer substrate comprises a plurality of parts and a coupled area linking the plurality of parts. Each of the plurality of parts comprises a signal via, ground vias surrounding the signal via, a radiation pad connected to one end of the signal via, a feed pad connected to another end of the signal vias, and an artificial medium disposed between the signal via and the ground vias. The multilayer substrate comprises a plurality of conductor layers isolated by a dielectric material.

### TECHNICAL FIELD

The present invention relates to a wideband antenna radiating element and method for producing a wideband antenna radiating element.

### BACKGROUND ART

Compact antenna radiating elements operating in a wide frequency band formed in a multilayer substrate and having considerably reduced dimensions due to application of an artificial medium (metamaterial) of a high effective relative permittivity.

In the above technical field, Patent Literature 1 discloses an aperture-based traveling wave antenna of an end-fire array which has a number of conductors and a director. Patent Literature 2 discloses a slot antenna which has a dielectric sheet, a metal sheet, a slot opening, a tapered opening and an impedance matching opening. Patent Literature 3 discloses a slot antenna which has a planar conductor, a tapered slot pattern and an impedance matching opening. Patent Literature 4 discloses a tapered slot antenna of end-fire array which has a dielectric substrate, a non-tapered slotline and a microstrip conductor. Patent Literature 5 discloses a dual Vivaldi antenna which has a first Vivaldi subantenna and a second Vivaldi subantenna electrically connected in parallel to the first Vivaldi subantenna. Patent Literature 6 discloses an antenna which has a first electrically conductive member including a first tapered element and a second electrically conductive member including a tapered feed portion and a first feed arm. Patent Literature 7 discloses an antenna which has a suspended air stripline, a ridged waveguide, an electromagnetic bandgap and one or more radiating elements. Patent Literature 8 discloses a tapered slot antenna element which has a tapered slot with a slot line and an inner wall. Patent Literature 9 discloses an antenna assembly which has a first radiating element module operable in at least a first frequency range and a second radiating element module operable in at least a second frequency range different from the first frequency range. Patent Literature 10 discloses a notch-antenna array which has at least one notch-antenna element possessing a first notch-antenna radiator and a second notch-antenna radiator disposed at an angle to the first notch-antenna radiator. Patent Literature 11 discloses an antenna which has a conductor having a rectangular volume extending along a longitudinal axis from a rear-side to a front-side edge, the conductor further has an aperture adjacent to the rear-side edge, a first slot extending from the aperture and a monopole element, Patent Literature 12 discloses a horn antenna which has a first plate, a second plate, a first ridge extending from the first plate towards the second plate, a second ridge extending from the second plate towards the first plate and a transmission line. Patent Literature 13 discloses a antenna which has two antenna elements forming a planar slotline antenna.

To provide imaging of an undersurface or a hidden object having small signal reflectivity, a high-gain antenna is necessary for a radar system. Also, to improve sensitivity and resolution of the radar system, the antenna has to be operating in a wide frequency band. However, typical wideband antennas (such as phased or sparse array antennas) with a high gain have large dimensions, especially, at a low-gigahertz frequency range, which considerably limits areas of its applications.

Thus, it is important to develop such antenna radiating elements which will be compact and wideband, as a result, can be use in lightweight radar systems having wide application areas.

It is an object of the present invention to provide compact and wideband antenna radiating elements based on multilayer substrate technologies which can be applied in lightweight radars.

### CITATION LIST

### Patent Literature

[PTL 1] US patent application publication No. US2010/0145190

[PTL 2] US patent application publication No. US2011/0273349

[PTL 3] US patent application publication No. US2011/0273350

[PTL 4] US patent application publication No. US2012/0313832

[PTL 5] US patent application publication No. US2013/0038495

[PTL 6] US patent application publication No. US2013/0214980

[PTL 7] US patent application publication No. US2013/0241791

[PTL 8] US patent application publication No. US2014/0085156

[PTL 9] US patent application publication No. US2014/0145890

[PTL 10] US patent application publication No. US2014/0218251

[PTL 11] US patent application publication No. US2014/0306854

[PTL 12] US patent application publication No. US2015/0002354

[PTL 13] US patent application publication No. US2015/0035707

### SUMMARY OF INVENTION

### Technical Problem

The present invention enables to provide a technique of solving the above-described problem.

### Solution to Problem

One aspect of the present invention provides a wideband antenna radiating element disposed in a multilayer substrate comprising:

a plurality of parts; and
a coupled area linking said plurality of parts;
wherein each of said plurality parts comprises:
a signal via;
ground vias surrounding said signal via;
a radiation pad connected to one end of said signal via;
a feed pad connected to another end of said signal vias; and
an artificial medium disposed between said signal via and said ground vias;
wherein said multilayer substrate comprises a plurality of conductor layers isolated by a dielectric material;
wherein said artificial medium is formed by conductor plates connected to said signal via and isolated from ground conductors by isolating slits, and conductor plates which are connected to ground vias and isolated from said signal via by clearance holes;
wherein said artificial medium has an effective relative permittivity variation in the direction perpendicular to the surface of said multilayer substrate; and
wherein said artificial medium in said plurality of parts has different effective relative permittivity.

Another aspect of the present invention provides a wideband antenna radiating element disposed in a multilayer substrate comprising:

three parts; and

a coupled area linking said three parts;

wherein each of said three parts comprises:

a signal via;

ground vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to ground vias and isolated from said signal via by clearance holes;

wherein said artificial medium has an effective relative permittivity variation in the direction perpendicular to the surface of said multilayer substrate; and

wherein said artificial medium in two edged parts of said three parts has same effective relative permittivity, while said artificial medium in the center part of said three parts is different from said two edged parts.

Still other aspect of the present invention provides a wideband antenna radiating element disposed in a multilayer substrate comprising:

five parts; and

a coupled area linking said five parts;

wherein each of said five parts comprises:

a signal via;

ground vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to ground vias and isolated from said signal via by clearance holes;

wherein said artificial medium has an effective relative permittivity variation in the direction perpendicular to the surface of said multilayer substrate; and

wherein said artificial medium in four edged parts of said five parts has same effective relative permittivity, while said artificial medium in the center part of said five parts is different from said four edged parts.

Yet other aspect of the present invention provides a method for producing a wideband antenna radiating element disposed in a multilayer substrate comprising: providing a plurality of parts; and

linking said plurality of parts by a coupled area;

wherein each of said plurality parts comprises:

a signal via;

ground vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to ground vias and isolated from said signal via by clearance holes;

wherein said artificial medium has an effective relative permittivity variation in the direction perpendicular to the surface of said multilayer substrate; and

wherein said artificial medium in said plurality of parts has different effective relative permittivity.

### Advantageous Effects of Invention

According to the present invention, it is possible to provide a compact and wideband antenna radiating elements based on multilayer substrate technologies which can be applied in lightweight radars. Moreover, according to the present invention, it is possible to provide a compact and wideband antenna radiating elements, as a result, can be used in lightweight radar systems having wide application areas.

### BRIEF DESCRIPTION OF DRAWINGS

FIG. 1A is a top view of a wideband antenna radiating element in an exemplary embodiment of the present invention.

FIG. 1B is a vertical cross-sectional view of the wideband antenna radiating element shown in FIG. 1A on the A-A line.

FIG. 1C is a horizontal cross-sectional view of the wideband antenna radiating element shown in FIG. 1B on conductor layers 1L2, 1L4 and 1L6.

FIG. 1D is a horizontal cross-sectional view of the wideband antenna radiating element shown in FIG. 1B on conductor layer 1L3.

FIG. 1E is a horizontal cross-sectional view of the wideband antenna radiating element shown in FIG. 1B on conductor layer 1 L5.

FIG. 1F is a horizontal cross-sectional view of the wideband antenna radiating element shown in FIG. 1B on conductor layer 1L7.

FIG. 1G is a bottom view of the wideband antenna radiating element shown in FIG. 1B.

FIG. 1H is an explanation of forming the wideband antenna radiating element proposed.

FIG. 1I is an explanation on obtaining different center frequencies for return losses in radiating elements 1 and 2.

FIG. 2A is a top view of a wideband antenna radiating element in another exemplary embodiment of the present invention.

FIG. 2B is a vertical cross-sectional view of the wideband antenna radiating element shown in FIG. 2A on the A-A line.

FIG. 2C is a horizontal cross-sectional view of the wideband antenna radiating element shown in FIG. 2B on conductor layers 2L2, 2L4 and 2L6.

FIG. 2D is a horizontal cross-sectional view of the wideband antenna radiating element shown in FIG. 2B on conductor layer 2L3.

FIG. 2E is a horizontal cross-sectional view of the wideband antenna radiating element shown in FIG. 2B on conductor layer 2L5.

FIG. 2F is a horizontal cross-sectional view of the wideband antenna radiating element shown in FIG. 2B on conductor layer 2L7.

FIG. 2G is a bottom view of the wideband antenna radiating element shown in FIG. 2B.

FIG. 3A is a top view of a wideband antenna radiating element in another exemplary embodiment of the present invention.

FIG. 3B is a vertical cross-sectional view of the wideband antenna radiating element shown in FIG. 3A on the A-A line.

FIG. 3C is a horizontal cross-sectional view of the wideband antenna radiating element shown in FIG. 3B on conductor layers 3L2, 3L4 and 3L6.

FIG. 3D is a horizontal cross-sectional view of the wideband antenna radiating element shown in FIG. 3B on conductor layer 3L3.

FIG. 3E is a horizontal cross-sectional view of the wideband antenna radiating element shown in FIG. 3B on conductor layer 3L5.

FIG. 3F is a horizontal cross-sectional view of the wideband antenna radiating element shown in FIG. 3B on conductor layer 3L5.

FIG. 3G is a bottom view of the wideband antenna radiating element shown in FIG. 3B.

FIG. 3H is a graph showing simulated return loss of the radiating element shown in FIGS. 3A-3G.

FIG. 4A is a top view of a wideband antenna radiating element in another exemplary embodiment of the present invention.

FIG. 4B is a vertical cross-sectional view of the wideband antenna radiating element shown in FIG. 4A on the A-A line.

FIG. 4C is a horizontal cross-sectional view of the wideband antenna radiating element shown in FIG. 4B on conductor layers 4L2, 4L4 and 4L6.

FIG. 4D is a horizontal cross-sectional view of the wideband antenna radiating element shown in FIG. 4B on conductor layer 4L3.

FIG. 4E is a horizontal cross-sectional view of the wideband antenna radiating element shown in FIG. 4B on conductor layer 4L5.

FIG. 4F is a horizontal cross-sectional view of the wideband antenna radiating element shown in FIG. 4B on conductor layer 4L7.

FIG. 4G is a bottom view of the wideband antenna radiating element shown in FIG. 4B.

FIG. 5A is a top view of a wideband antenna radiating element in another exemplary embodiment of the present invention.

FIG. 5B is a vertical cross-sectional view of the wideband antenna radiating element shown in FIG. 5A on the A-A line.

FIG. 5C is a vertical cross-sectional view of the wideband antenna radiating element shown in FIG. 5A on the B-B line.

FIG. 5D is a horizontal cross-sectional view of the wideband antenna radiating element shown in FIG. 5B and conductor layers 5C on 5L2, 5L4 and 5L6.

FIG. 5E is a horizontal cross-sectional view of the wideband antenna radiating element shown in FIGS. 5B and 5C on conductor layer 5L3.

FIG. 5F is a horizontal cross-sectional view of the wideband antenna radiating element shown in FIGS. 5B and 5C on conductor layer 5L5.

FIG. 5G is a horizontal cross-sectional view of the wideband antenna radiating element shown in FIGS. 5B and 5C on conductor layer 5L7.

FIG. 5H is a bottom view of the wideband antenna radiating element shown in FIGS. 5B and 5C.

FIG. 6A is a top view of a wideband antenna radiating element in another exemplary embodiment of the present invention.

FIG. 6B is a vertical cross-sectional view of the wideband antenna radiating element shown in FIG. 6A on the A-A line.

FIG. 6C is a horizontal cross-sectional view of the wideband antenna radiating element shown in FIG. 6B on conductor layers 6L2, 6L4, 2L6, 6L8 and 6L10.

FIG. 6D is a horizontal cross-sectional view of the wideband antenna radiating element shown in FIG. 6B on conductor layer 6L3.

FIG. 6E is a horizontal cross-sectional view of the wideband antenna radiating element shown in FIG. 6B on conductor layer 6L5.

FIG. 6F is a horizontal cross-sectional view of the wideband antenna radiating element shown in FIG. 6B on conductor layer 6L7.

FIG. 6G is a horizontal cross-sectional view of the wideband antenna radiating element shown in FIG. 6B on conductor layer 6L9.

FIG. 6H is a bottom view of the wideband antenna radiating element shown in FIG. 6B.

### DESCRIPTION OF EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

In an aspect of the present invention, such compact and wideband antenna radiating elements are provided by forming coupled structures designed vertically in a substrate (perpendicular to the substrate surface). Each part of a coupled structure is obtained by a signal via surrounding by ground vias. Its compactness is provided by an artificial medium (metamaterial) of a high effective relative permittivity, which is disposed between the signal and ground vias. Wideband operation of proposed radiating elements is achieved by the artificial medium in each part of the coupled structure which has variable effective permittivity in the vertical direction (perpendicular to the substrate surface) and providing different center frequencies for return losses of each part forming coupled structure.

### First Embodiment

Hereinafter, several types of wideband antenna radiating elements disposed in multilayer substrates according to the present invention will be described in details with reference to attached drawings. But, it would be well understood that this description should not be viewed as narrowing the appended claims.

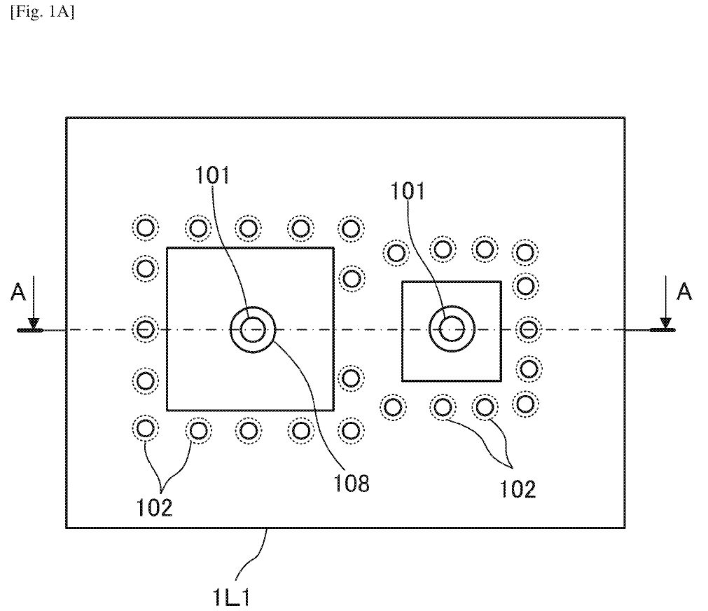

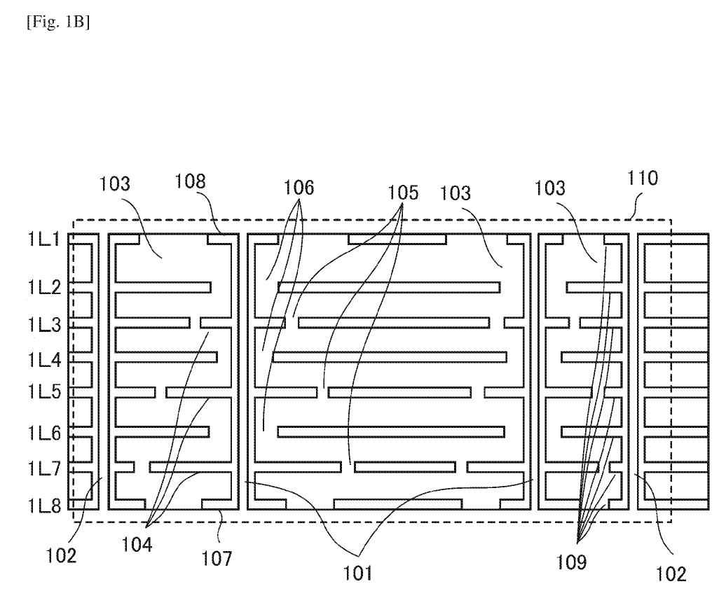

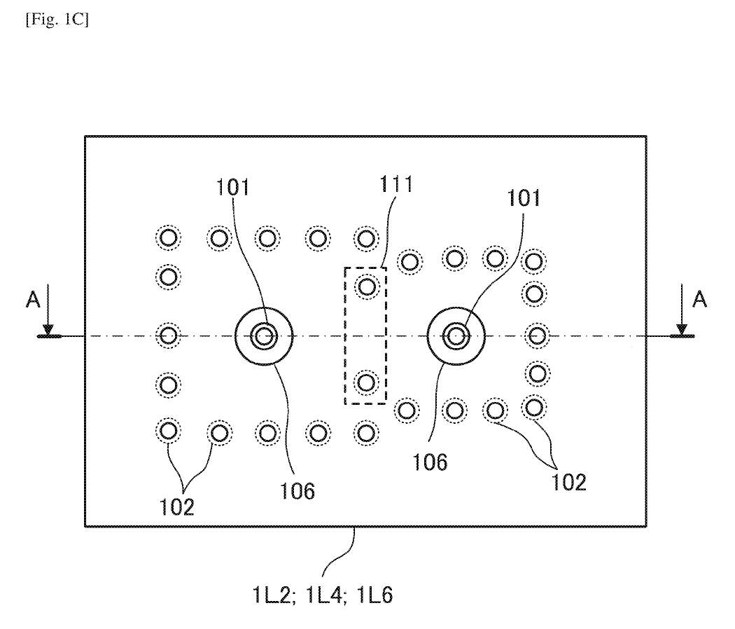

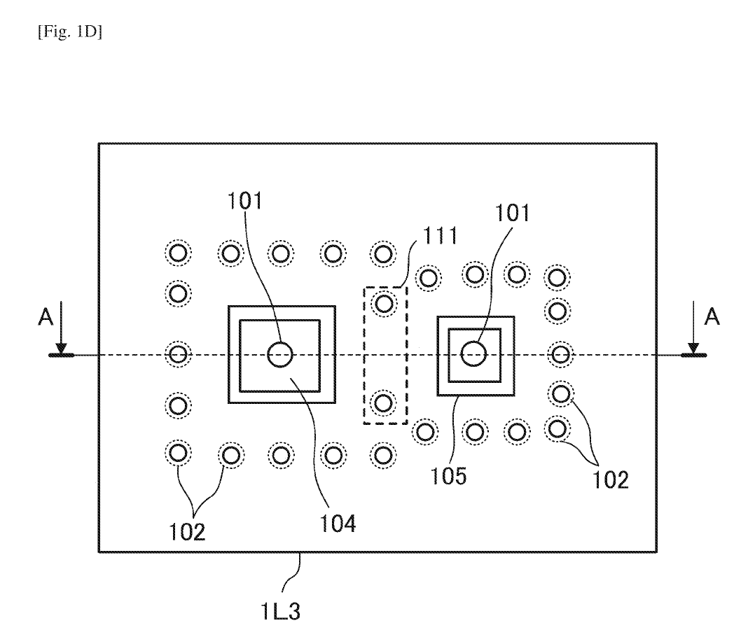

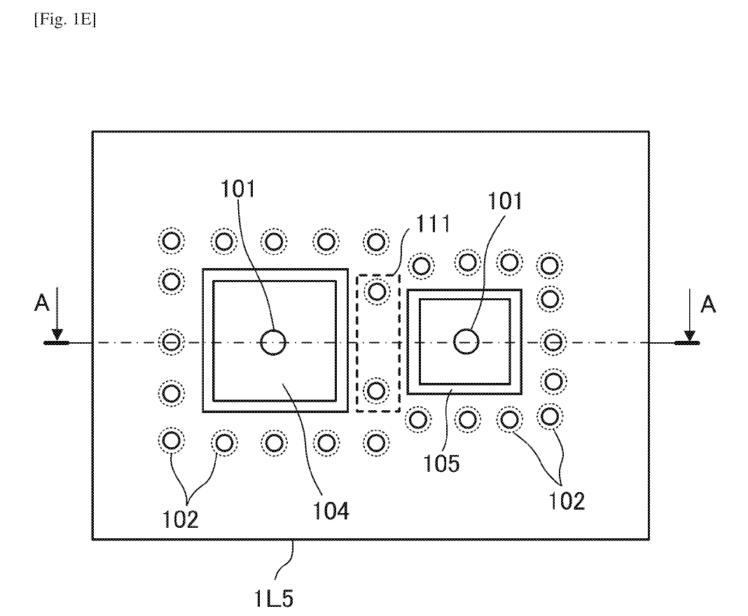

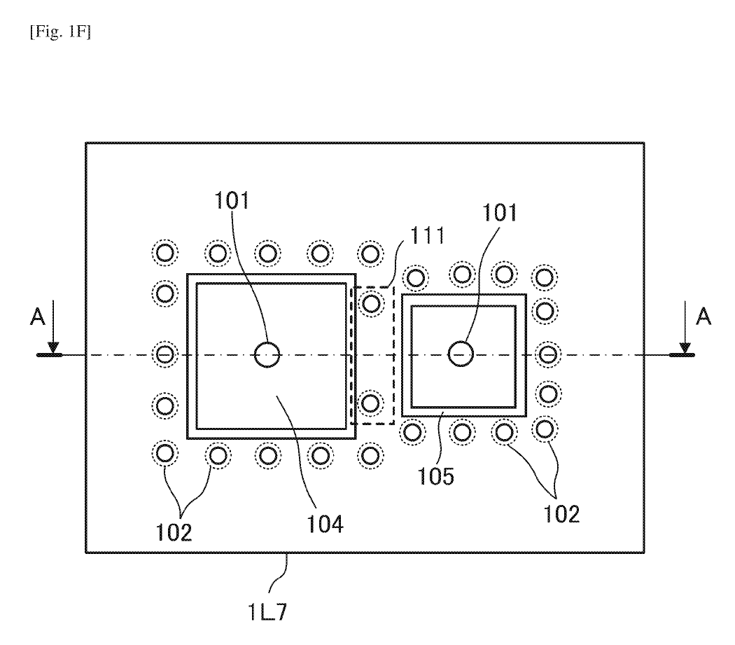

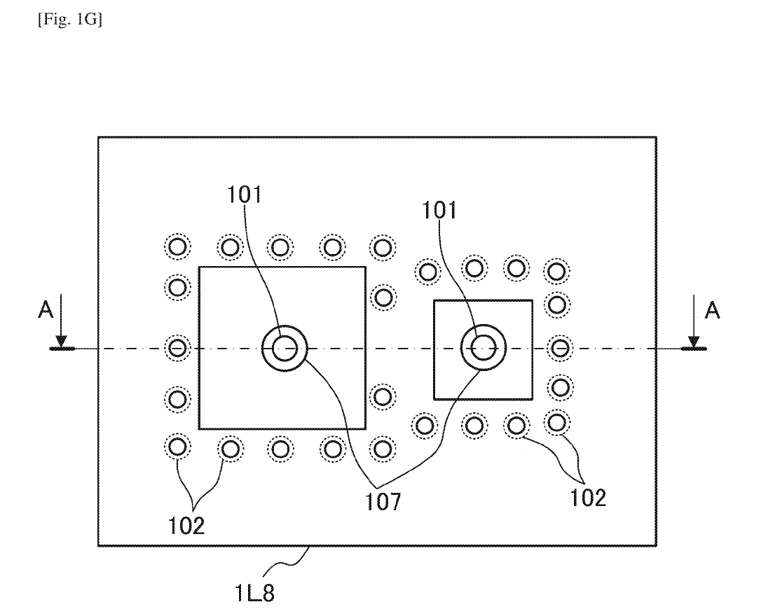

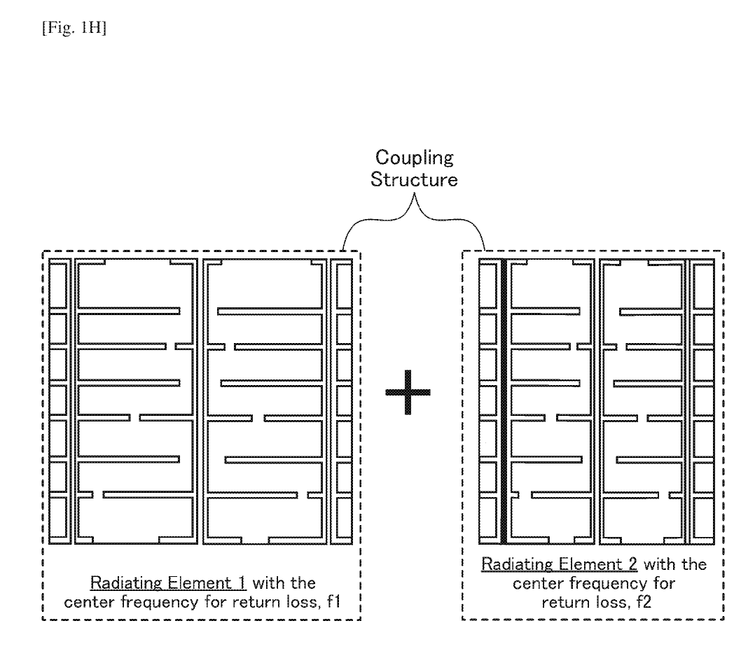

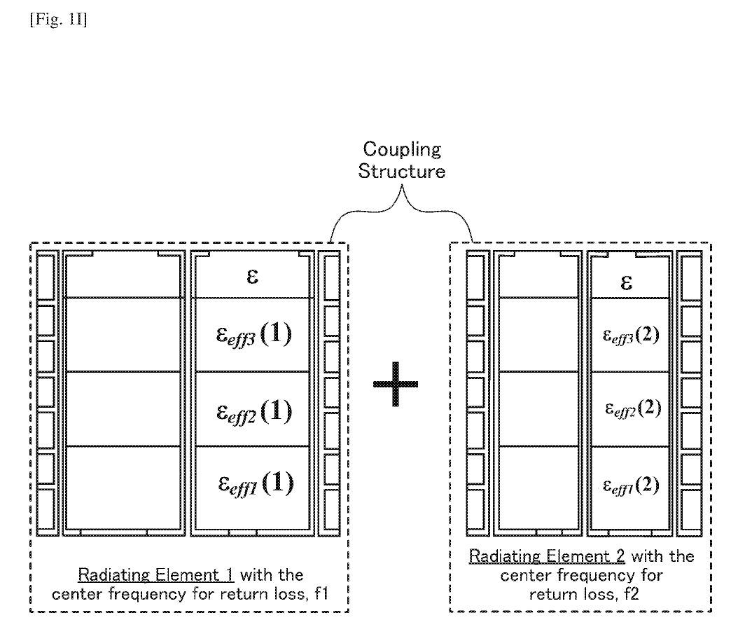

In FIGS. 1A to 1G, an exemplary embodiment of wideband antenna radiating element 110 disposed in a multilayer substrate is shown. This multilayer substrate is provided with a number of conductor layers 1L1 to 1L8. Eight conductor layers 1L1 to 1L8 are isolated by dielectric material 103.

Note this eight conductor layer substrate is only an example of multilayer substrates and a number of conductor layers, filling material and other substrate parameters can be different that depends on an application.

In the present embodiment, wideband antenna radiating element 110 is formed by two parts coupled with each other by coupling area 111. Each of said two parts comprises signal via 101 and ground vias 102 surrounding signal via 101 and connected to ground conductor plates 109. Such wideband antenna radiating element 110 has low leakage losses and, as a result, a minor coupling to neighboring radiating elements if it is used in a sparse or a phased array antenna. Wideband antenna radiating element 110 has compact dimensions due to a high effective relative permittivity of an artificial medium (metamaterial) which is formed between signal via 101 and ground vias 102 in each the part of wideband antenna radiating element 110. This artificial medium is obtained by conductor plates 104 connected to signal via 101 and conductor plates 109 connected to ground vias 102. Conductor plates 104 are separated from ground conductor plates 109 by isolating slits 105, and around conductor plates 109 are isolated from signal via 101 by clearance holes 106. Radiation pads 108 are connected to one end of signal vias 101 and other ends of signal vias 101 are connected to feed pads 107. Radiation pads 108 are separated from ground conductor plates 109 disposed at conductor layer 1L1 by dielectric material 103. Feed pads 107 are separated from ground conductor plates 109 disposed at conductor layer 1L8 by dielectric material 103.

In this patent application, widening the operation band in the antenna radiating element is achieved by the application of the two parts having different center frequencies f1 and f2 for return losses as shown in FIG. 1H. This difference is obtained by forming the artificial mediums in the two parts having distinctive effective permittivities.

Also it is important to note that the artificial medium has an effective relative permittivity in each of the two parts which is variable in the vertical direction, that is, perpendicularly to the surface of the multilayer substrate. In FIG. 1L a physical model of the artificial medium between the signal via and the ground vias is presented for each of the two parts.

In radiating element 1 shown in FIGS. 1H and 1I, a structure between signal via 101 and ground vias 102 is replaced by the corresponding homogeneous medium with effective relative permittivity epsilon_{eff1} (1), epsilon_{eff2} (1), or epsilon_{eff3} (1) as dependency on the conductor layer, while in radiating element 2 shown in FIG. 1H and a structure between signal via 101 and ground vias 102 is replaced by the corresponding homogeneous medium with effective relative permittivity epsilon_{eff1} (2), epsilon_{eff2} (2), or epsilon_{eff3} (3) as dependency on the conductor layer.

In the first part characterized by the center frequency for return losses, f1, the artificial medium can be specified by the effective relative permittivity, epsilon_{eff1} (1), epsilon_{eff2} (1), and epsilon_{eff3} (1) each of which is dependent on dimensions of conductor plates 104, isolating slits 105 and clearance holes 106. In the second part characterized by the center frequency for return losses, f2, the artificial medium can be specified by the effective relative permittivity, epsilon_{eff1} (2), epsilon_{eff2} (2), and epsilon_{eff3} (2) each of which is dependent on dimensions of conductor plates 104, isolating slits 105 and clearance holes 106. To provide a wideband operation of wideband antenna radiating element 110 epsilon_{eff1} (1), epsilon_{eff2} (1), and epsilon_{eff3} (1) as well as epsilon_{eff1} (2), epsilon_{eff2} (2), and epsilon_{eff3} (2) are chosen in such way that epsilon_{eff1} (1) greater than epsilon_{eff2} (1) greater than epsilon_{eff3} (1) and epsilon_{eff1} (2) greater than epsilon_{eff2} (2) greater than epsilon_{eff3} (2).

### Second Embodiment

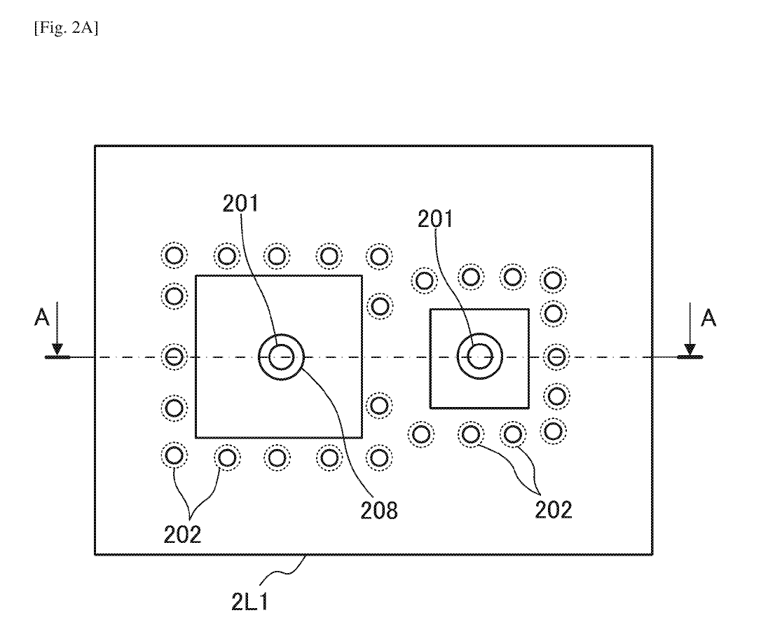

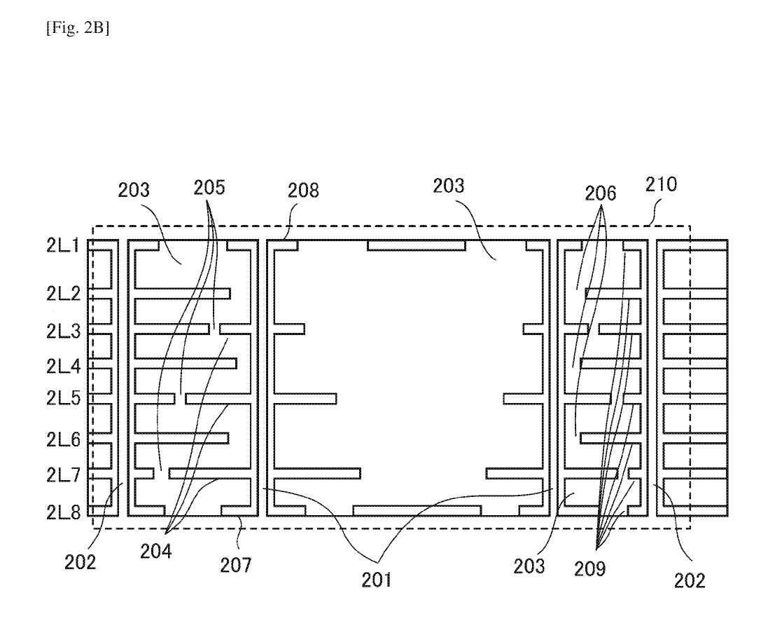

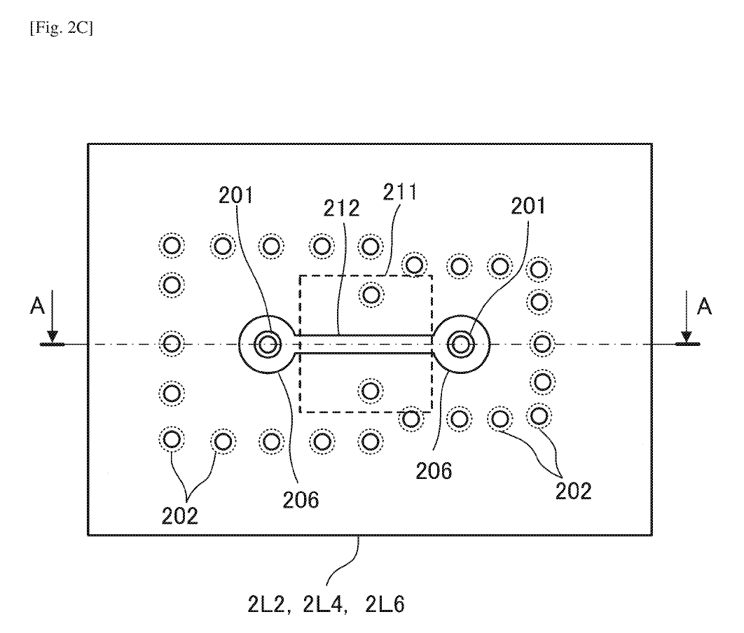

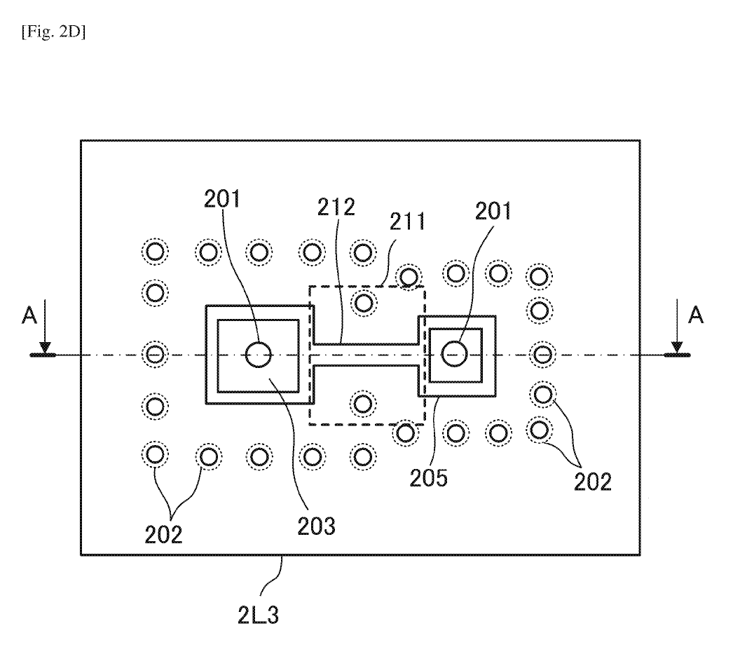

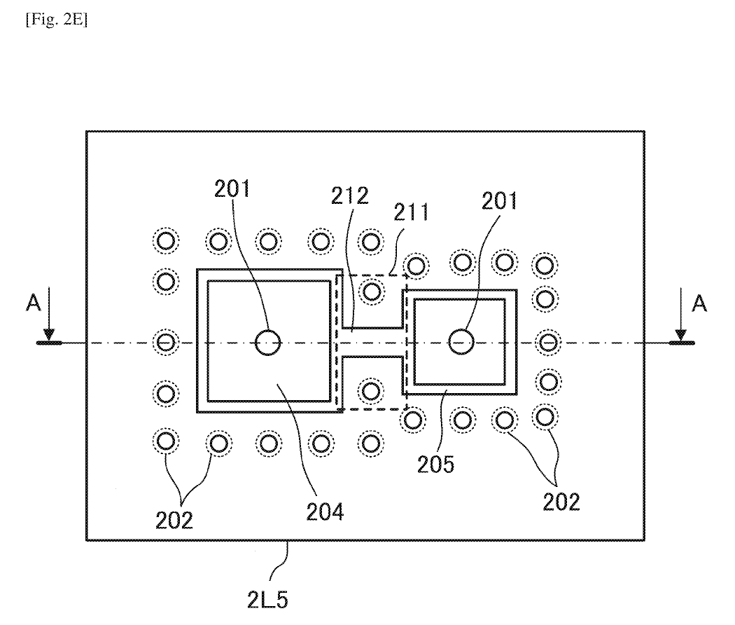

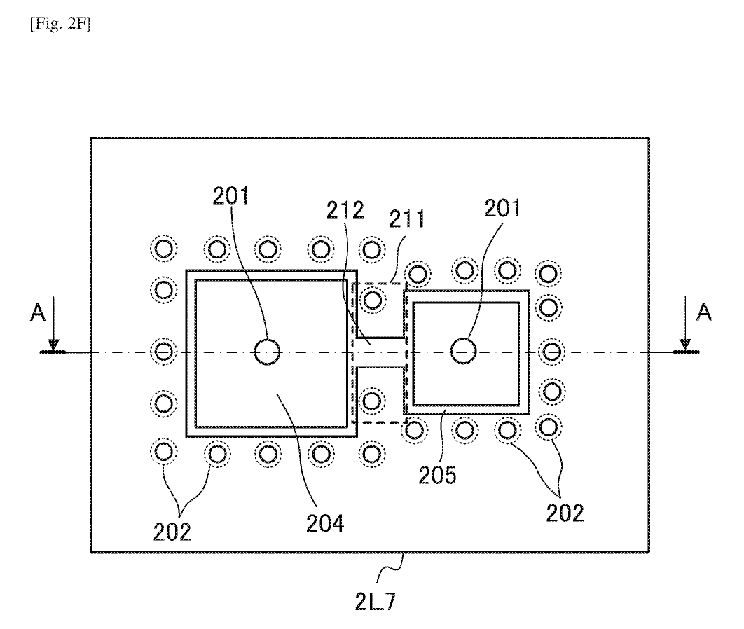

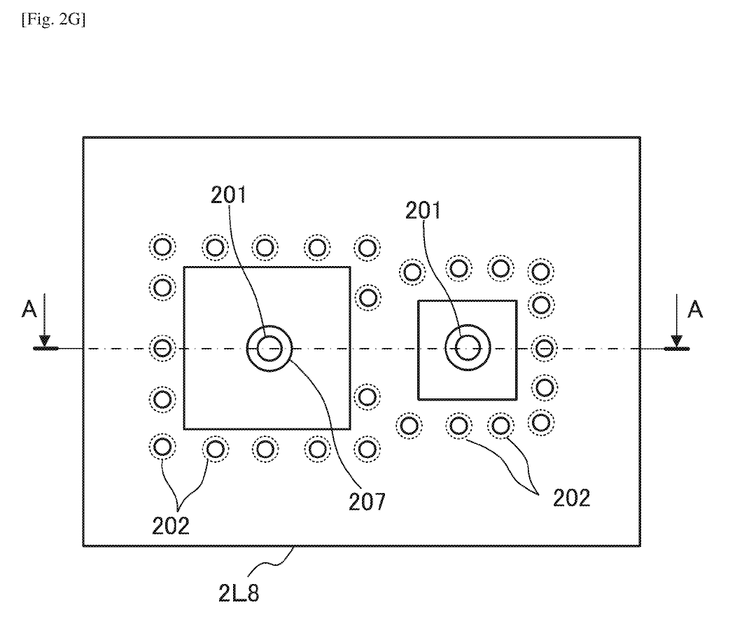

In FIGS. 2A to 2G, another exemplary embodiment of wideband antenna radiating element 210 disposed in a multilayer substrate is shown. This multilayer substrate is provided with a number of conductor layers 2L1 to 2L8. Eight conductor layers 2L1 to 2L8 are isolated by dielectric material 203.

In the present embodiment, wideband antenna radiating element 210 is formed by two parts coupled with each other by coupling area 211. In coupling area 211, an addition link between the two parts is carried out by slits 212 disposed in 2L2, 2L3, 2L4, 2L5, 2L6 and 2L7 conductor layers. Each of the two parts comprises signal via 201 and ground vias 202 surrounding signal via 201 and connected to ground conductor plates 209. Wideband antenna radiating element 210 has compact dimensions due to a high effective relative permittivity of an artificial medium which is formed between signal via 201 and ground vias 202 in each the part of wideband antenna radiating element 210. This artificial medium is obtained by conductor plates 204 connected to signal via 201 and ground conductor plates 209 connected to ground vias 202. Conductor plates 204 are separated from ground conductor plates 209 by isolating slits 205, and ground conductor plates 209 are isolated from signal via 201 by clearance holes 206. Radiation pads 208 are connected to one end of signal vias 201 and other ends of signal vias 201 are connected to feed pads 207. Radiation pads 208 are separated from ground conductor plates 209 disposed at conductor layer 2L1 by dielectric material 203. Feed pads 207 are separated from ground conductor plates 209 disposed at conductor layer 2L8 by dielectric material 203.

### Third Embodiment

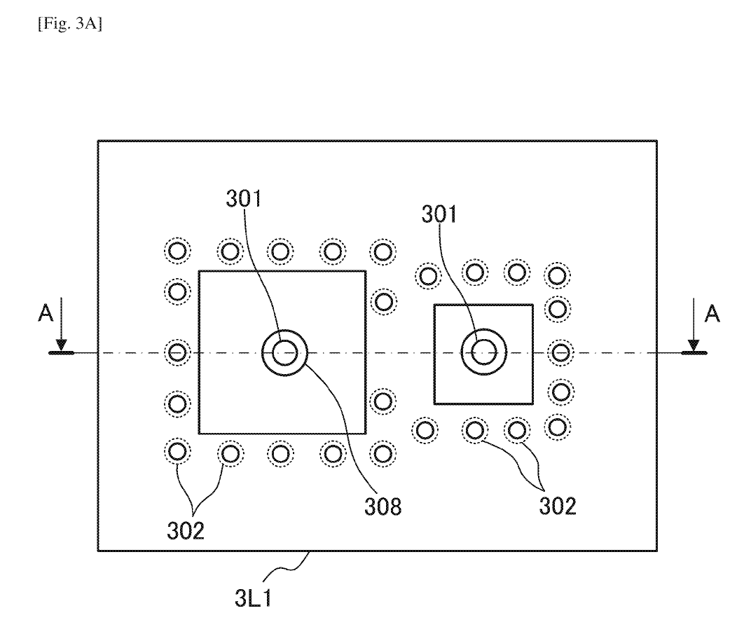

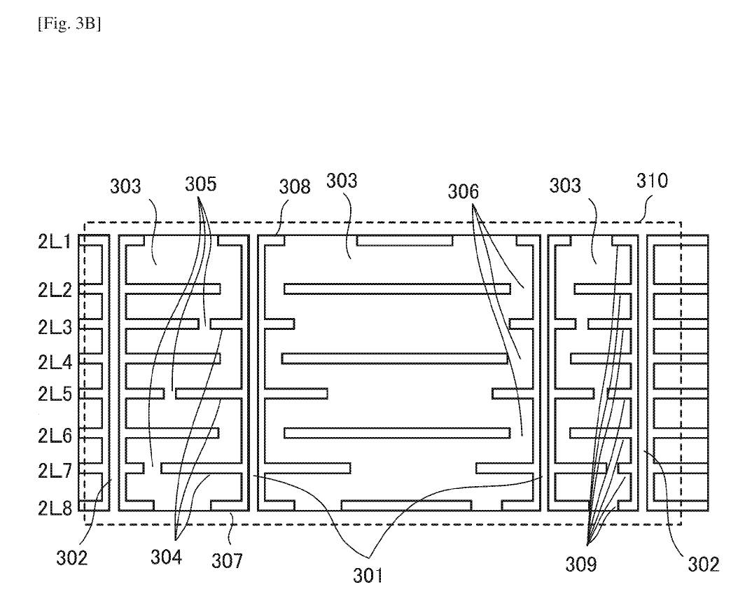

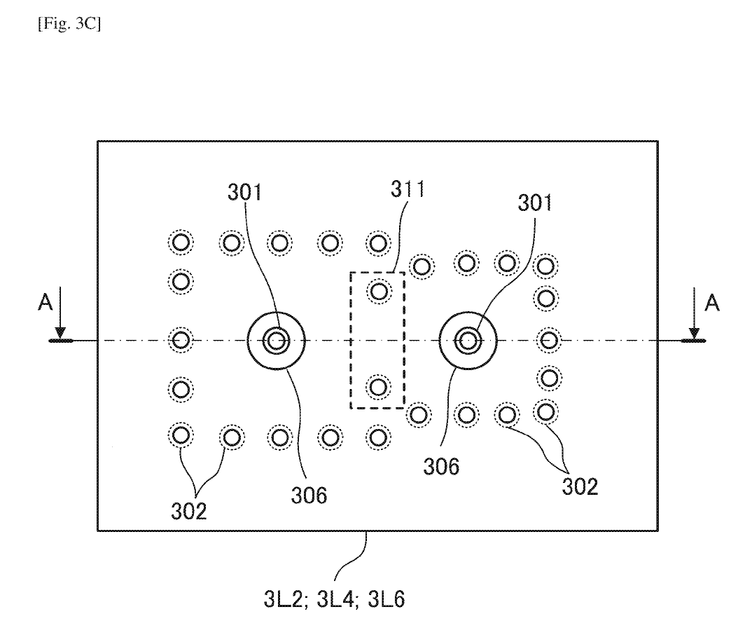

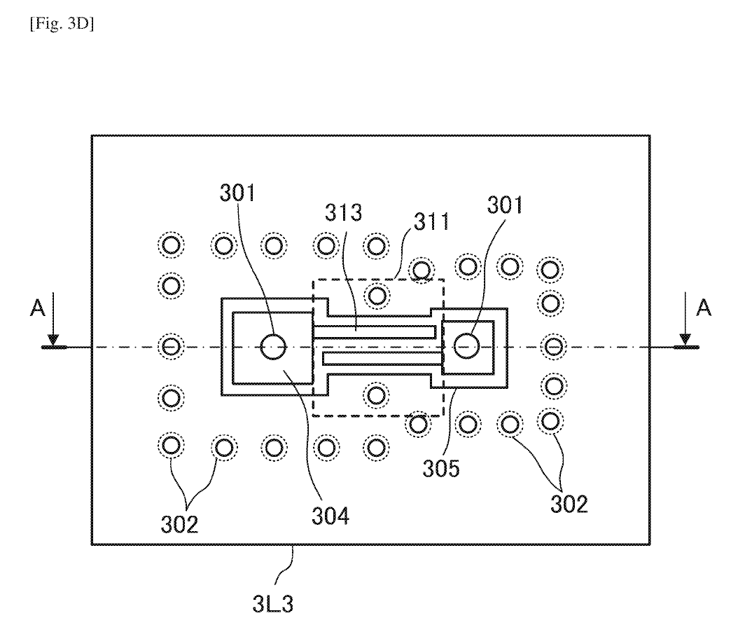

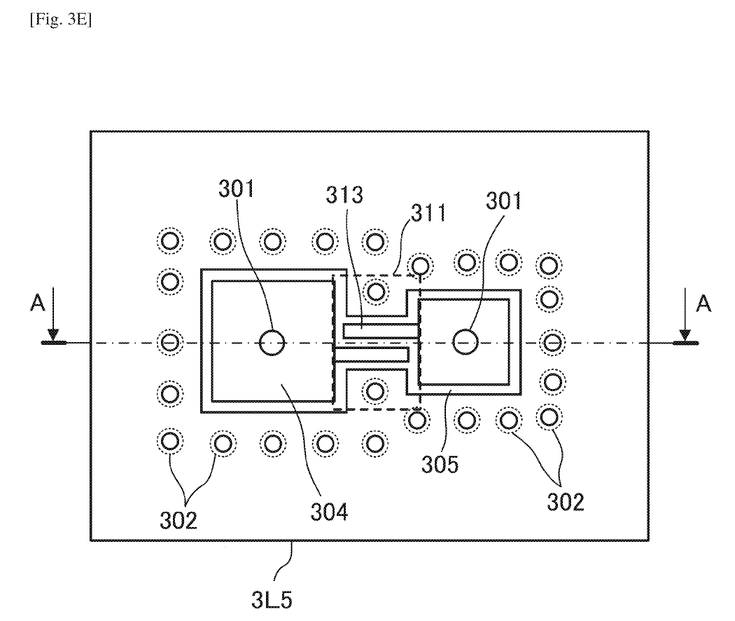

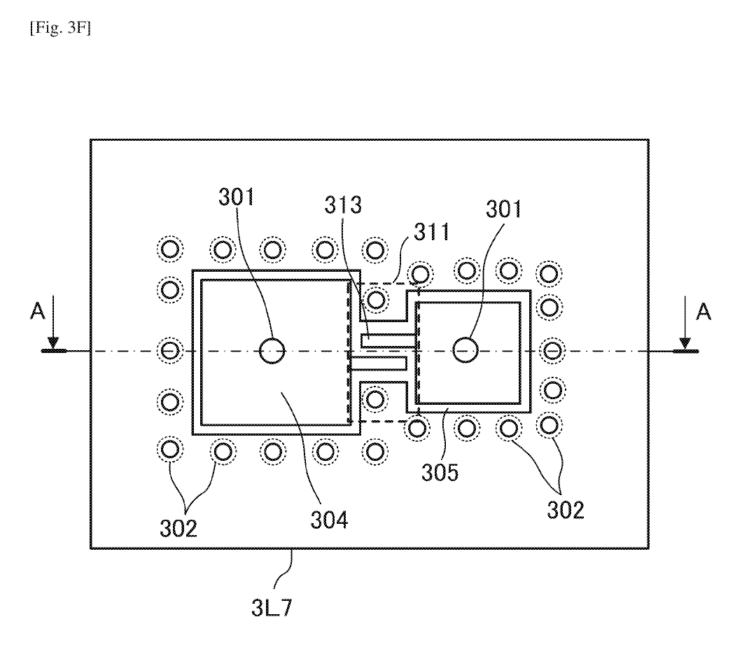

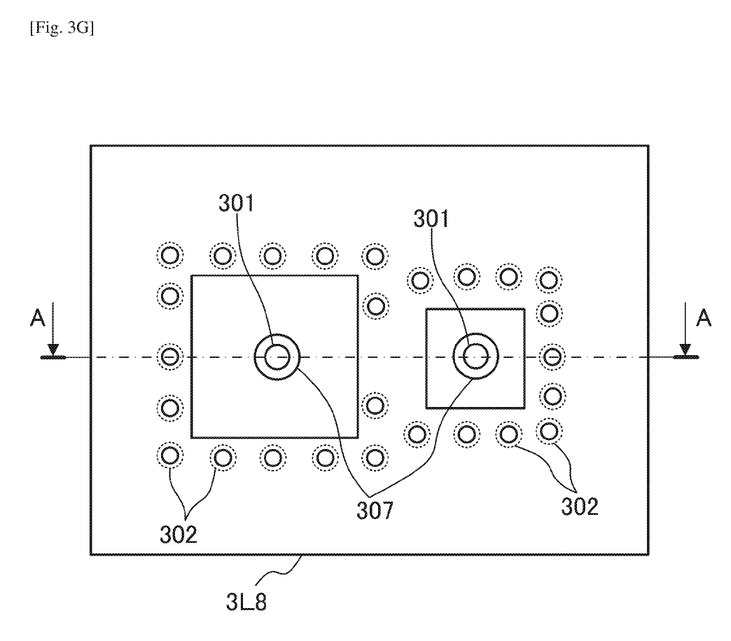

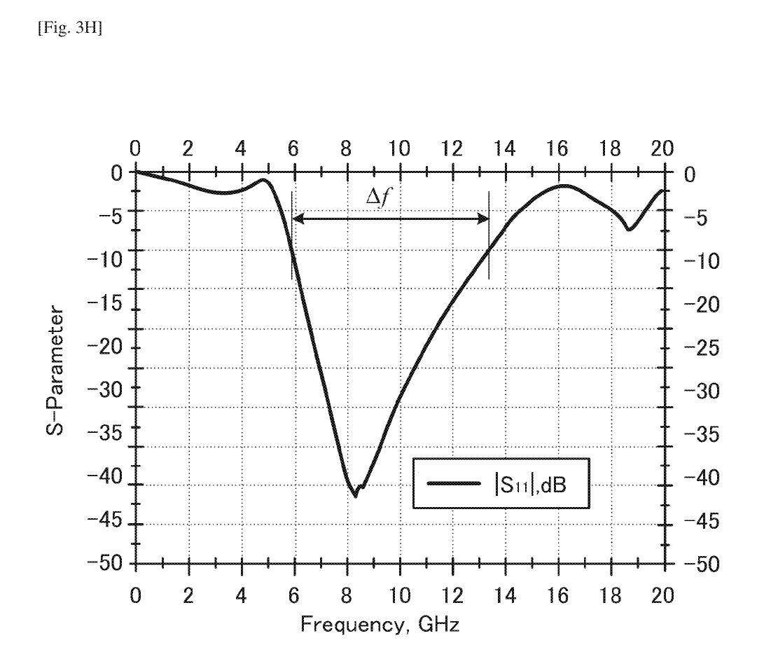

In FIGS. 3A to 3G, another exemplary embodiment of wideband antenna radiating element 310 disposed in a multilayer substrate is shown. This multilayer substrate is provided with a number of conductor layers 3L1 to 3L8. Eight conductor layers 3L1 to 3L8 are isolated by dielectric material 303.

In the present embodiment, wideband antenna radiating element 310 is formed by two parts coupled with each other by coupling area 311. In coupling area 311, an addition connection between the two parts is carried out by coupled strips 313 disposed in 3L3, 3L5, and 3L7 conductor layers. Each of the two parts comprises signal via 301 and ground vias 302 surrounding signal via 301 and connected to ground conductor plates 309. Wideband antenna radiating element 310 has compact dimensions due to a high effective relative permittivity of an artificial medium which is formed between signal via 301 and ground vias 302 in each the part of wideband antenna radiating element 310. This artificial medium is obtained by conductor plates 304 connected to signal via 301 and ground conductor plates 309 connected to ground vias 302. Conductor plates 304 are separated from ground conductor plates 309 by isolating slits 305, and ground conductor plates 309 are isolated from signal via 301 by clearance holes 306. Radiation pads 308 are connected to one end of signal vias 301 and other ends of signal vias 301 are connected to feed pads 307. Radiation pads 308 are separated from ground conductor plates 309 disposed at conductor layer 3L1 by dielectric material 303. Feed pads 307 are separated from ground conductor plates 309 disposed at conductor layer 3L8 by dielectric material 303.

In FIG. 3H, simulated data of the return loss of a wideband antenna radiating element for which its structure is shown in FIGS. 3A-3G are presented. Transverse dimensions (limited by ground vias) of the first part and the second part of this wideband antenna radiating element were 5 mm by 5 mm and 4 mm by 4 mm, respectively, 8 copper conductor layers were isolated by FR-4 (Flame Retardant-4) material and the thickness of the substrate was 2 mm. As follows from obtained simulation data, developed wideband antenna radiating element has the bandwidth of about 7.8 GHz taken at the return loss level of −10 dB. Thus, the wideband antenna radiating element developed is compact and broadband one.

### Fourth Embodiment

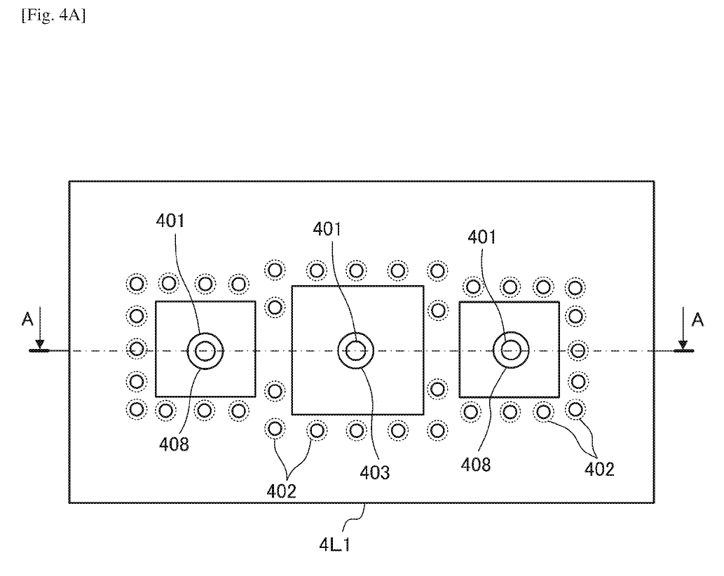

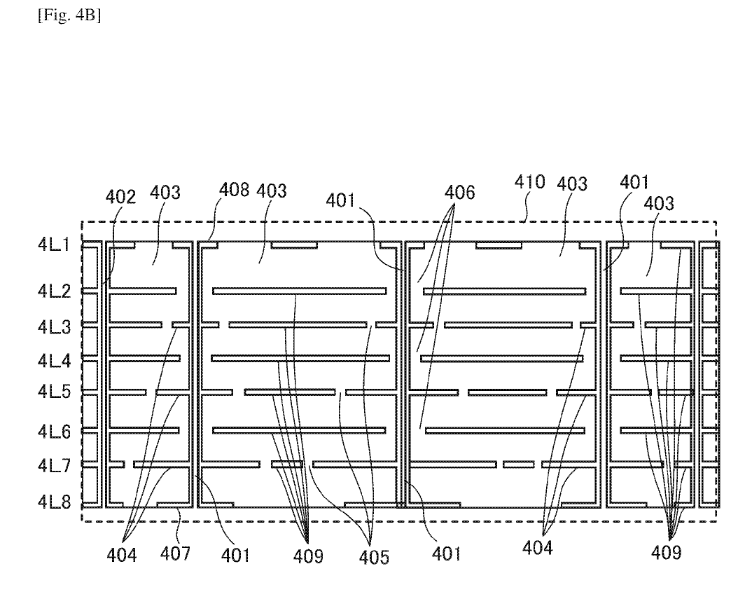

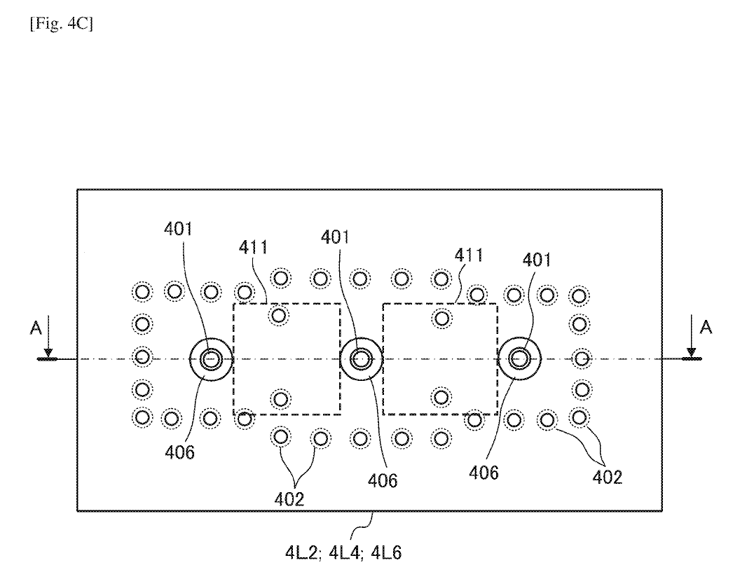

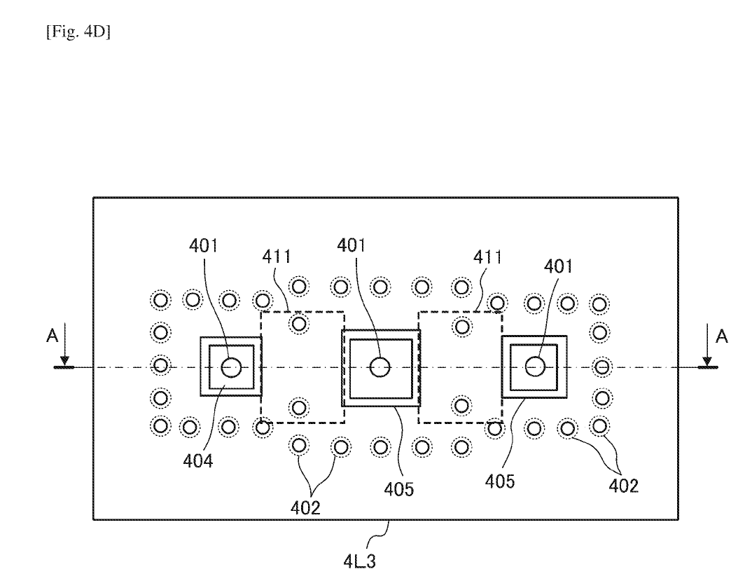

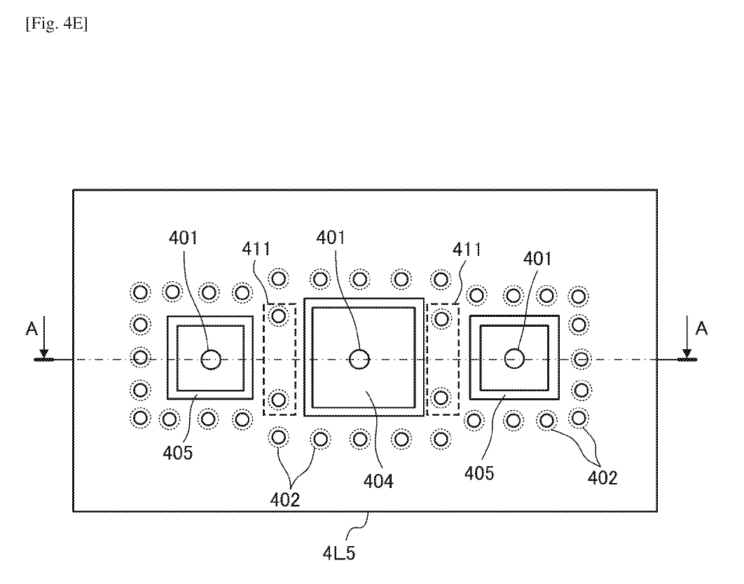

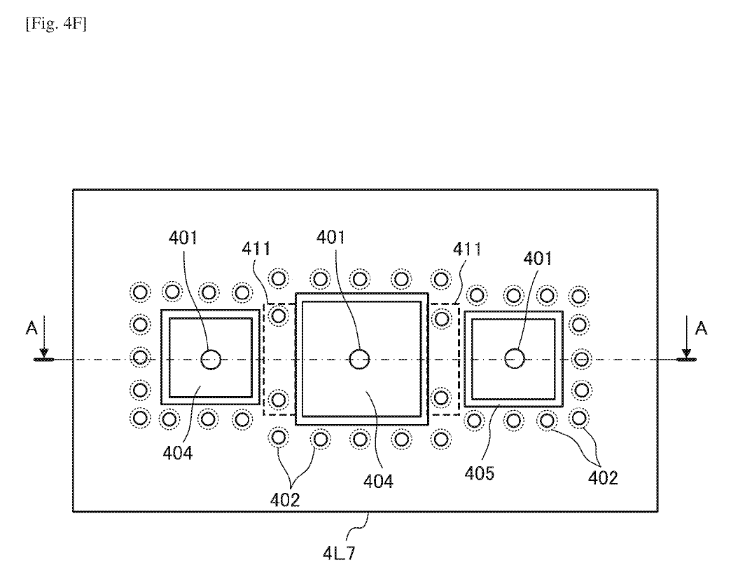

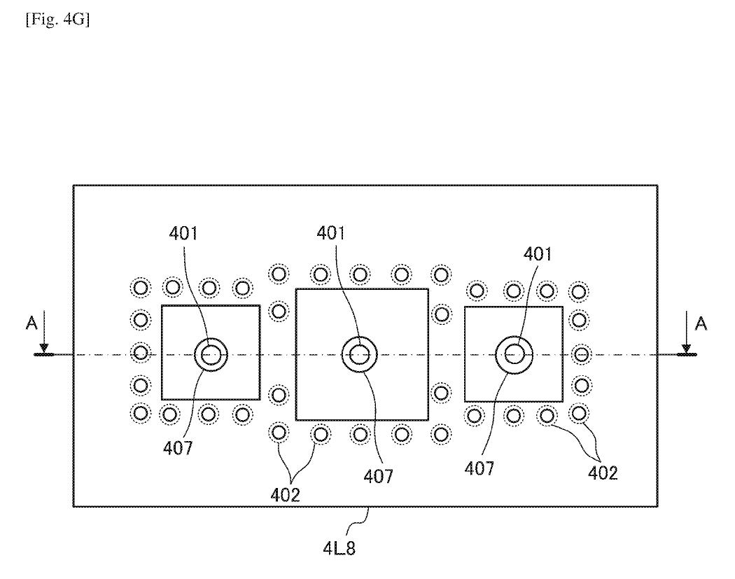

In FIGS. 4A to 4G, another exemplary embodiment of wideband antenna radiating element 410 disposed in a multilayer substrate is shown. This multilayer substrate is provided with a number of conductor layers 4L1 to 4L8. Eight conductor layers 4L1 to 4L8 are isolated by dielectric material 403.

In the present embodiment, wideband antenna radiating element 410 is formed by three parts coupled with each other by coupling area 411. Two edged parts have the same dimensions and, as a result, same effective permittivity of an artificial medium filling in these two edged parts. Each of the three parts comprises signal via 401 and ground vias 402 surrounding signal via 401 and connected to ground conductor plates 409. Wideband antenna radiating element 410 has compact dimensions due to a high effective relative permittivity of an artificial medium which is formed between signal via 401 and ground vias 402 in each part of wideband antenna radiating element 410. This artificial medium is obtained by conductor plates 404 connected to signal via 401 and ground conductor plates 409 connected to ground vias 402. Conductor plates 404 are separated from ground conductor plates 409 by isolating slits 405, and ground conductor plates 409 are isolated from signal via 401 by clearance holes 406. Radiation pads 408 are connected to one end of signal vias 401 and other ends of signal vias 401 are connected to feed pads 407. Radiation pads 408 are separated from ground conductor plates 409 disposed at conductor layer 4L1 by dielectric material 403. Feed pads 407 are separated from ground conductor plates 409 disposed at conductor layer 4L8 by dielectric material 403.

### Fifth Embodiment

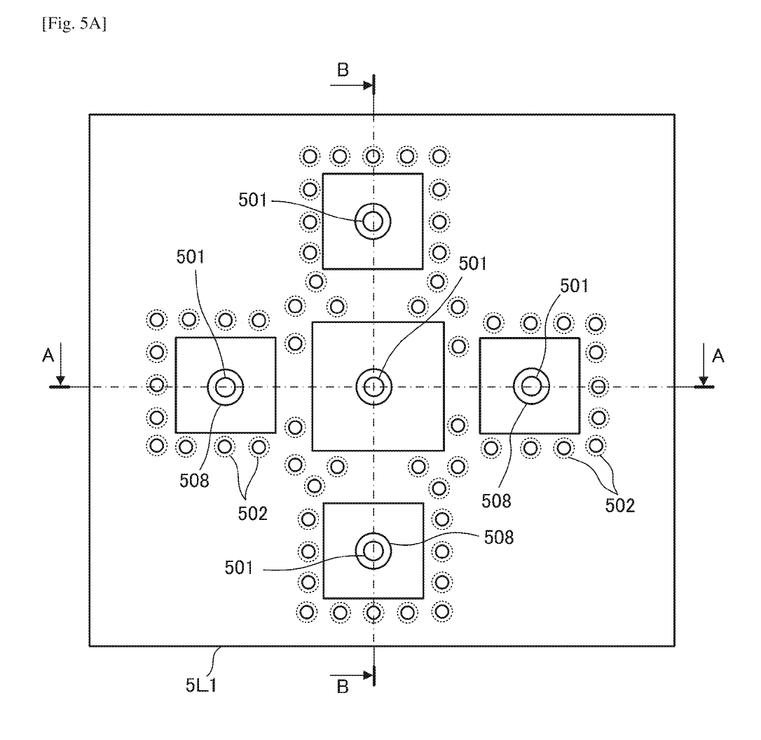

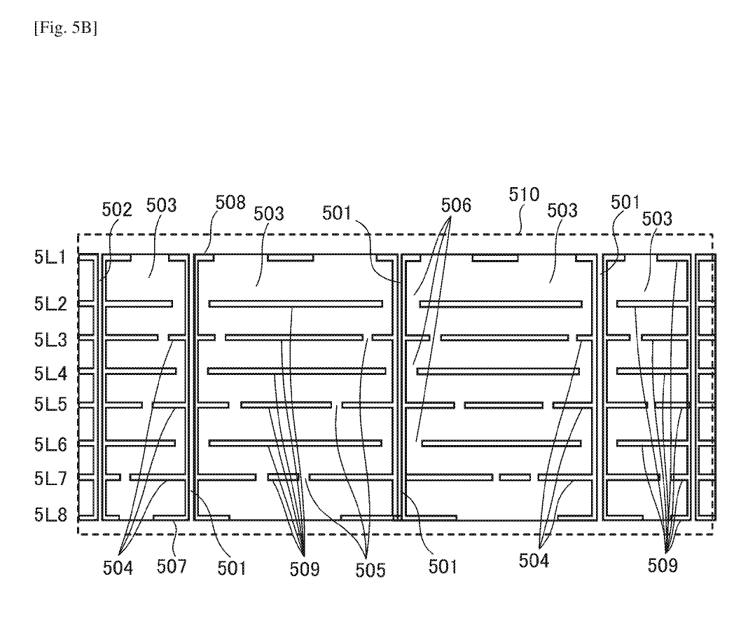

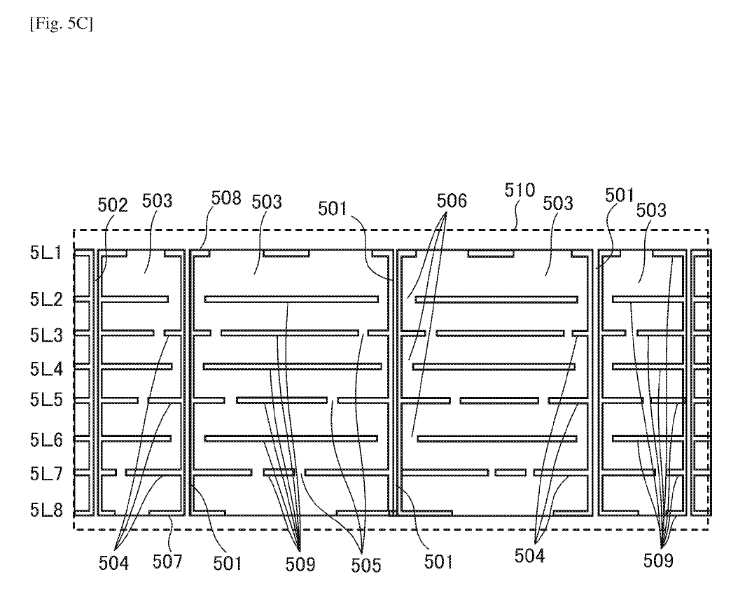

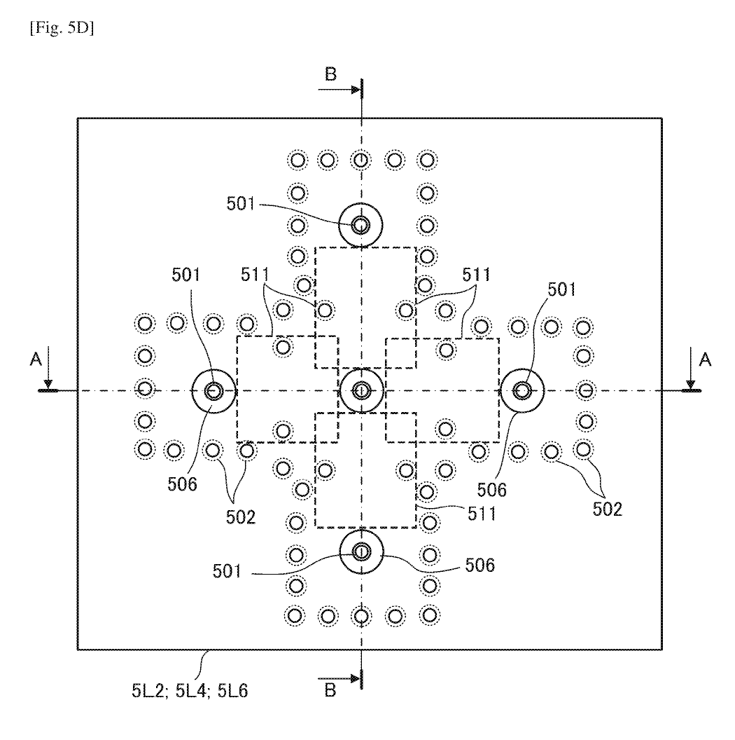

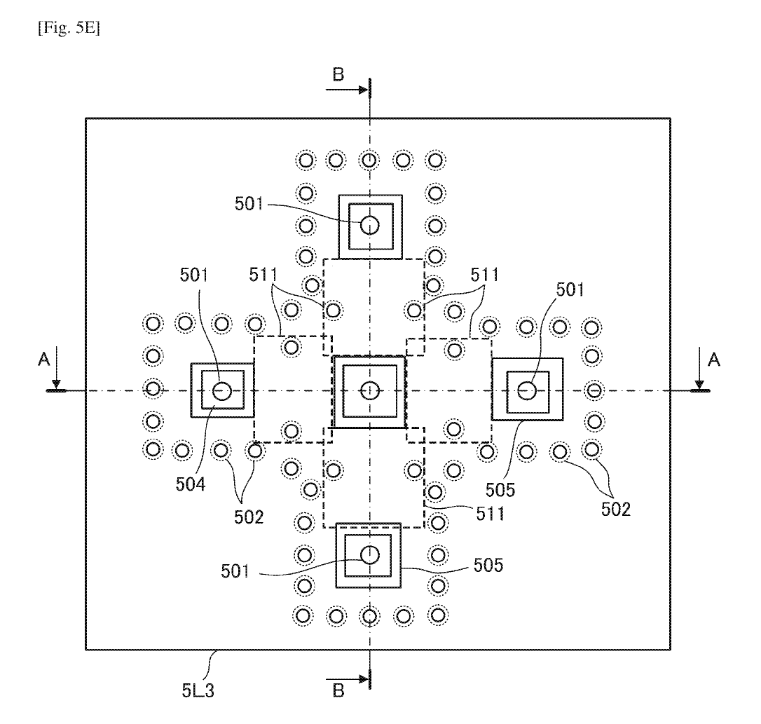

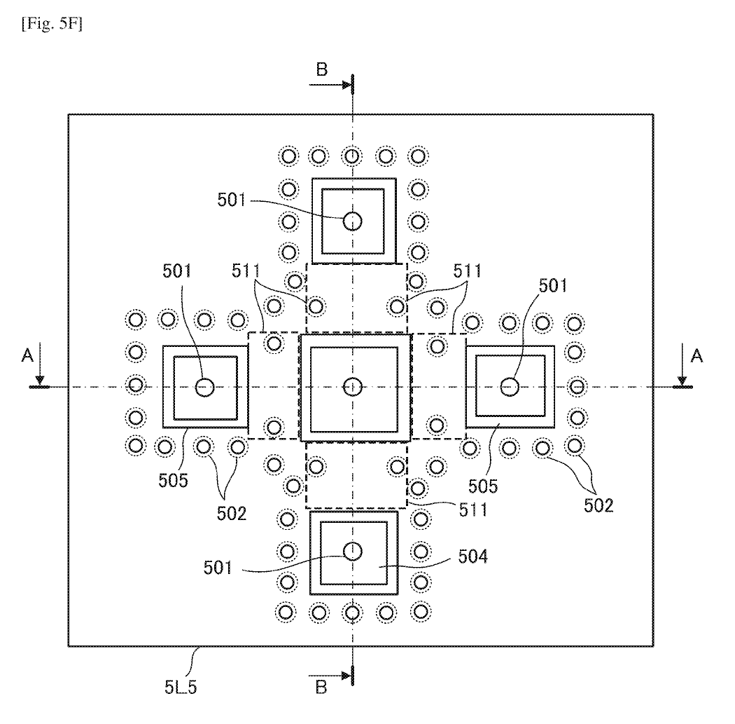

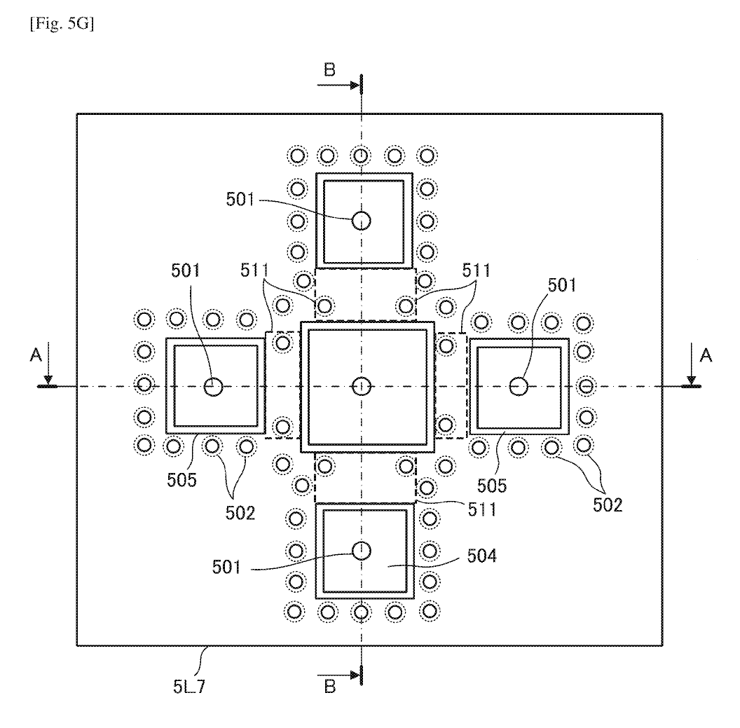

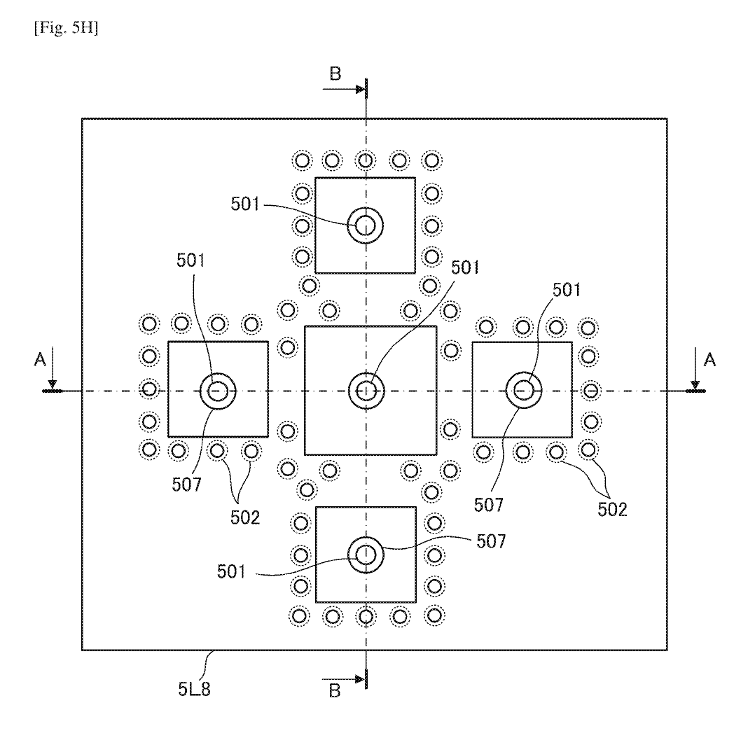

In FIGS. 5A to 5H, another exemplary embodiment of wideband antenna radiating element 510 disposed in a multilayer substrate is shown. This multilayer substrate is provided with a number of conductor layers 5L1 to 5L8. Eight conductor layers 5L1 to 5L8 are isolated by dielectric material 503.

In the present embodiment, wideband antenna radiating element 510 is formed by five parts coupled with each other by coupling area 511. Four edged parts have the same dimensions and, as a result, same effective permittivity of an artificial medium filling in these four edge parts. Each of the five parts comprises signal via 501 and ground vias 502 surrounding signal via 501 and connected to ground conductor plates 509. Wideband antenna radiating element 510 has compact dimensions due to a high effective relative permittivity of an artificial medium which is formed between signal via 501 and ground vias 502 in each part of wideband antenna radiating element 510. This artificial medium is obtained by conductor plates 504 connected to signal via 501 and ground conductor plates 509 connected to ground vias 502. Conductor plates 504 are separated from ground conductor plates 509 by isolating slits 505, and ground conductor plates 509 are isolated from signal via 501 by clearance holes 506. Radiation pads 508 are connected to one end of signal vias 501 and other ends of signal vias 501 are connected to feed pads 507. Radiation pads 508 are separated from ground conductor plates 509 disposed at conductor layer 5L1 by dielectric material 503. Feed pads 507 are separated from ground conductor plates 509 disposed at conductor layer 5L8 by dielectric material 503.

### Sixth Embodiment

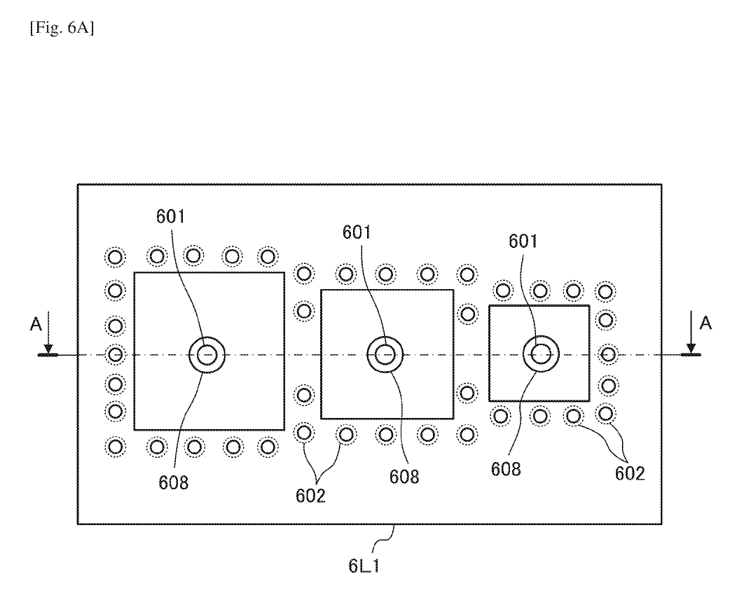

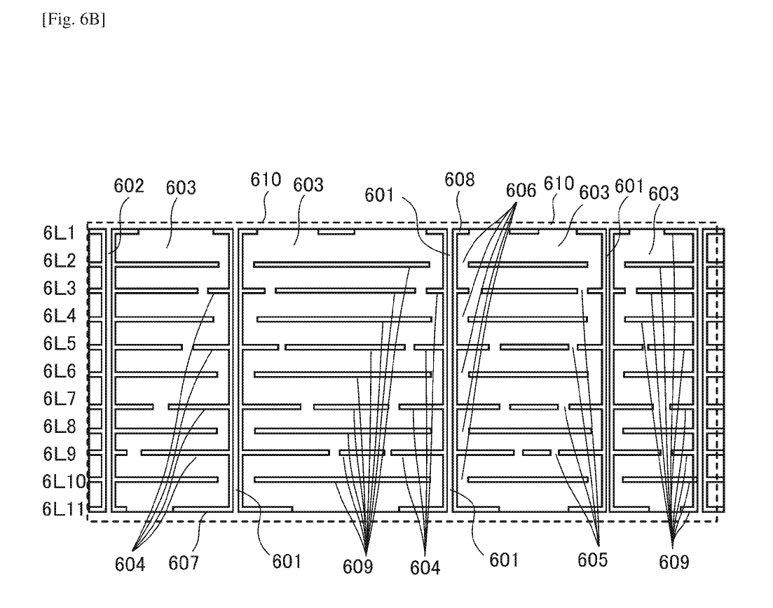

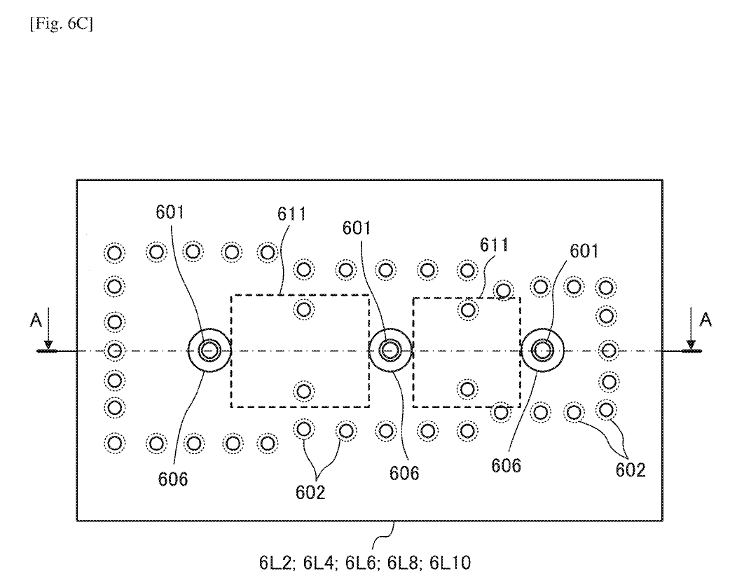

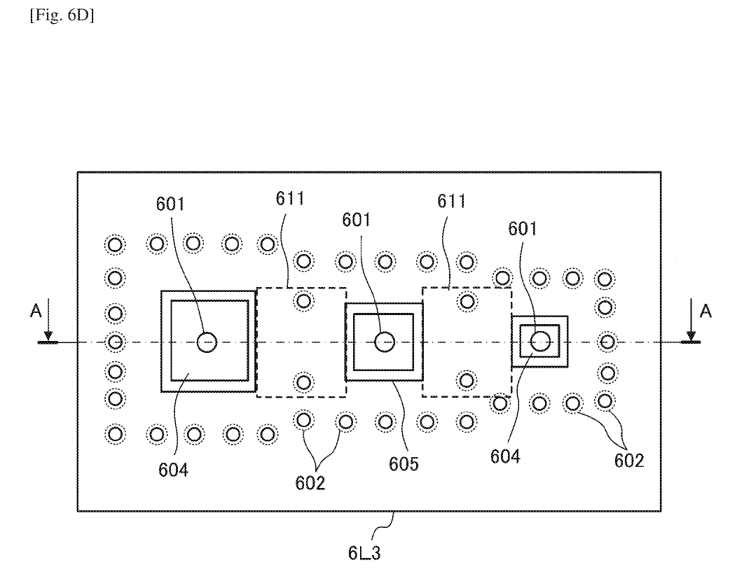

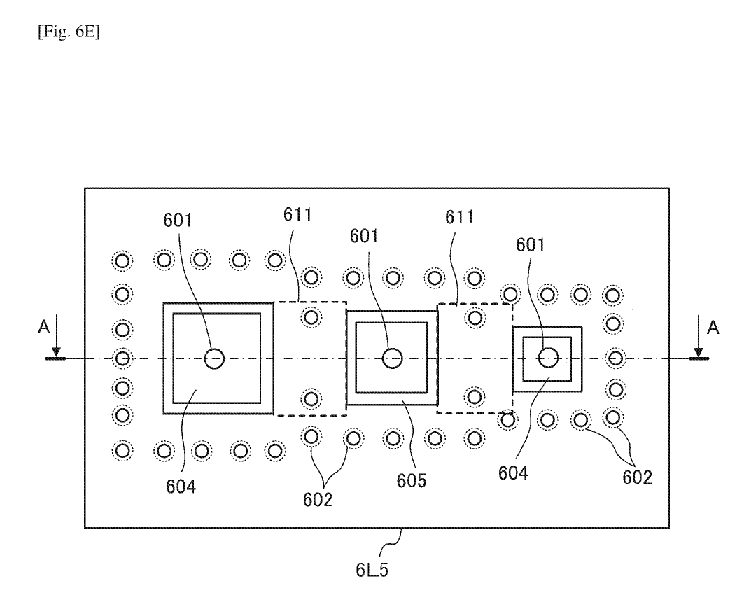

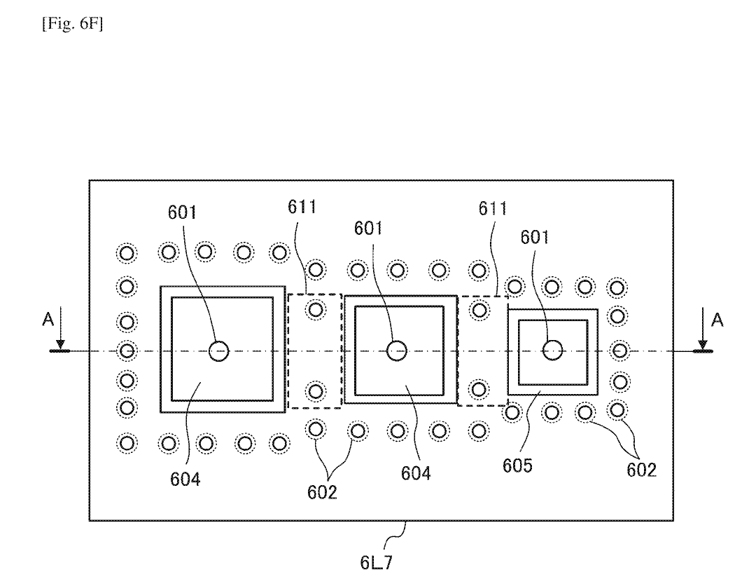

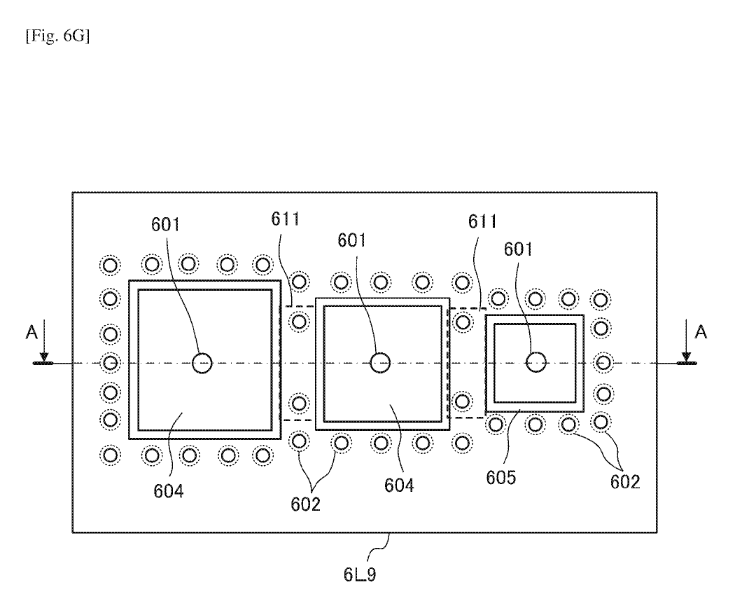

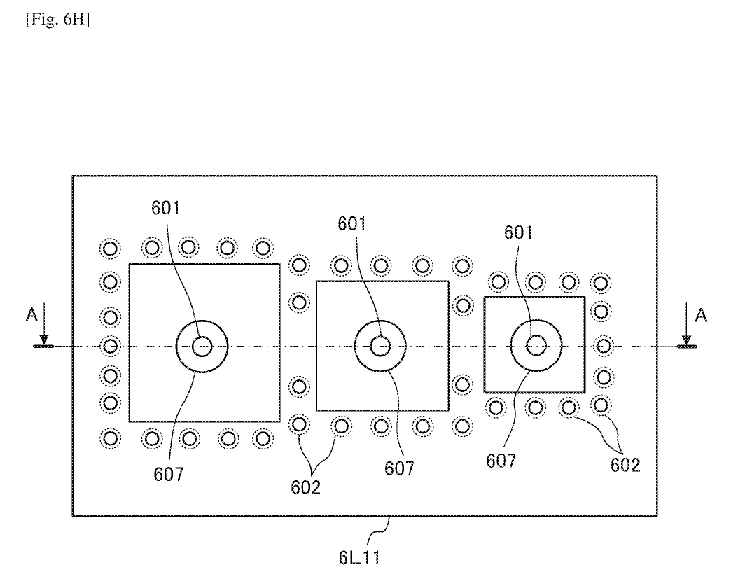

In FIGS. 6A to 6H, another exemplary embodiment of wideband antenna radiating element 610 disposed in a multilayer substrate is shown. This multilayer substrate is provided with a number of conductor layers 6L1 to 6L11. Eleven conductor layers 6L1 to 6L11 are isolated by dielectric material 603.

In the present embodiment, wideband antenna radiating element 610 is formed by three parts coupled with each other by coupling area 611. Each of the three parts has different dimensions. And, as a result, each part can be characterized by distinctive center frequencies for antenna return losses. Application of such structure in wideband antenna radiating element 610 leads to further widening of the antenna operation band. Each of the three parts comprises signal via 601 and ground vias 602 surrounding signal via 601 and connected to around conductor plates 609. Wideband antenna radiating element 610 has compact dimensions due to a high effective relative permittivity of an artificial medium which is formed between signal via 601 and ground vias 602 in each part of wideband antenna radiating element 610. This artificial medium is obtained by conductor plates 604 connected to signal via 601 and ground conductor plates 609 connected to ground vias 602. Conductor plates 604 are separated from ground conductor plates 609 by isolating slits 605, and ground conductor plates 609 are isolated from signal via 601 by clearance holes 606. Radiation pads 608 are connected to one end of signal vias 601 and other ends of signal vias 601 are connected to feed pads 607. Radiation pads 608 are separated from ground conductor plates 609 disposed at conductor layer 6L1 by dielectric material 603. Feed pads 607 are separated from ground conductor plates 609 disposed at conductor layer 6L11 by dielectric material 603.

### Other Embodiments

While the present invention has been described in relation to some exemplary embodiments, it is to be understood that these exemplary embodiments are for the purpose of description by example, and not of limitation. While it will be obvious to those skilled in the art upon reading the present specification that various changes and substitutions may be easily made by equal components and art, it is obvious that such changes and substitutions lie within the true scope and spirit of the presented invention as defined by the claims.

### Other Exemplaryer Embodiments

Some or all of the above-described embodiments can also be described as in the following further exemplary embodiments, but are not limited to the followings.

### Further Exemplary Embodiment 1

A wideband antenna radiating element disposed in a multilayer substrate comprising: a plurality of parts; and

a coupled area linking said plurality of parts;

wherein each of said plurality parts comprises:

a signal via;

ground vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to around vias and isolated from said signal via by clearance holes;

wherein said artificial medium has an effective relative permittivity variation in the direction perpendicular to the surface of said multilayer substrate; and

wherein said artificial medium in said plurality of parts has different effective relative permittivity.

### Further Exemplary Embodiment 2

The wideband antenna radiating element according to further exemplary embodiment 1, wherein said coupled area comprises a slit providing an additional link between said plurality of parts.

### Further Exemplary Embodiment 3

The wideband antenna radiating element according to further exemplary embodiment 1, wherein said coupled area comprises a coupled strip structure providing an additional link between said plurality of parts.

### Further Exemplary Embodiment 4

The wideband antenna radiating element according to further exemplary embodiment 1, wherein said plurality of parts is two parts or three parts.

### Further Exemplary Embodiment 5

A wideband antenna radiating element disposed in a multilayer substrate comprising: three parts; and

a coupled area linking said three parts;

wherein each of said three parts comprises:

a signal via;

ground vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to ground vias and isolated from said signal via by clearance holes;

wherein said artificial medium has an effective relative permittivity variation in the direction perpendicular to the surface of said multilayer substrate; and

wherein said artificial medium in two edged parts of said three parts has same effective relative permittivity, while said artificial medium in the center part of said three parts is different from said two edged parts.

### Further Exemplary Embodiment 6

The wideband antenna radiating element according to further exemplary embodiment 5, wherein said coupled area comprises a slit providing an additional link between said two edge parts.

### Further Exemplary Embodiment 7

The wideband antenna radiating element according to further exemplary embodiment 5, wherein said coupled area comprises a coupled strip structure providing an additional link between said two edge parts.

### Further Exemplary Embodiment 8

A wideband antenna radiating element disposed in a multilayer substrate comprising: five parts; and

a coupled area linking said five parts;

wherein each of said five parts comprises:

a signal via;

around vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to ground vias and isolated front said signal via by clearance holes;

wherein said artificial medium has an effective relative permittivity variation in the direction perpendicular to the surface of said multilayer substrate; and

wherein said artificial medium in four edged parts of said five parts has same effective relative permittivity, while said artificial medium in the center part of said five parts is different from said four edged parts.

### Further Exemplary Embodiment 9

The wideband antenna radiating element according to further exemplary embodiment 8, wherein said coupled area comprises a slit providing an additional link between said four edge parts.

### Further Exemplary Embodiment 10

The wideband antenna radiating element according to further exemplary embodiment 8, wherein said coupled area comprises a coupled strip structure providing an additional link between said four edge parts.

### Further Exemplary Embodiment 11

A method for producing a wideband antenna radiating element disposed in a multilayer substrate comprising:

providing a plurality of parts; and

linking said plurality of parts by a coupled area;

wherein each of said plurality parts comprises:

a signal via;

ground vias surrounding said signal via;

a radiation pad connected to one end of said signal via;

a feed pad connected to another end of said signal vias; and

an artificial medium disposed between said signal via and said ground vias;

wherein said multilayer substrate comprises a plurality of conductor layers isolated by a dielectric material;

wherein said artificial medium is formed by conductor plates connected to said signal via and isolated from ground conductors by isolating slits, and conductor plates which are connected to ground vias and isolated from said signal via by clearance holes;

wherein said artificial medium has an effective relative permittivity variation in the direction perpendicular to the surface of said multilayer substrate; and

wherein said artificial medium in said plurality of parts has different effective relative permittivity.

What is claimed is:

1. A wideband antenna radiating element disposed in a multilayer substrate comprising:
a plurality of parts; and
a coupled area linking said plurality of parts;
wherein each of said plurality parts comprises:
a signal via;
ground vias surrounding said signal via;
a radiation pad connected to one end of said signal via;
a feed pad connected to another end of said signal vias; and
an artificial medium disposed between said signal via and said ground vias;
wherein said multilayer substrate comprises a plurality of conductor layers isolated by a dielectric material;
wherein said artificial medium is formed by conductor plates connected to said signal via and isolated from ground conductors by isolating slits,
and conductor plates which are connected to ground vias and isolated from said signal via by clearance holes;
wherein said artificial medium has an effective relative permittivity variation in the direction perpendicular to the surface of said multilayer substrate; and
wherein said artificial medium in said plurality of parts has different effective relative permittivity.

2. The wideband antenna radiating element according to claim 1, wherein said coupled area comprises a slit providing an additional link between said plurality of parts.

3. The wideband antenna radiating element according to claim 1, wherein said coupled area comprises a coupled strip structure providing an additional link between said plurality of parts.

4. A wideband antenna radiating element disposed in a multilayer substrate comprising:
three parts; and
a coupled area linking said three parts;
wherein each of said three parts comprises:
a signal via;
ground vias surrounding said signal via;
a radiation pad connected to one end of said signal via;
a feed pad connected to another end of said signal vias; and
an artificial medium disposed between said signal via and said ground vias;
wherein said multilayer substrate comprises a plurality of conductor layers isolated by a dielectric material;
wherein said artificial medium is formed by conductor plates connected to said signal via and isolated from ground conductors by isolating slits,
and conductor plates which are connected to ground vias and isolated from said signal via by clearance holes;
wherein said artificial medium has an effective relative permittivity variation in the direction perpendicular to the surface of said multilayer substrate; and
wherein said artificial medium in two edged parts of said three parts has same effective relative permittivity, while said artificial medium in the center part of said three parts is different from said two edged parts.

5. The wideband antenna radiating element according to claim 4, wherein said coupled area comprises a slit providing an additional link between said two edge parts.

6. The wideband antenna radiating element according to claim 4, wherein said coupled area comprises a coupled strip structure providing an additional link between said two edge parts.

7. A wideband antenna radiating element disposed in a multilayer substrate comprising:
five parts; and
a coupled area linking said five parts;
wherein each of said five parts comprises:
a signal via;
ground vias surrounding said signal via;
a radiation pad connected to one end of said signal via;
a feed pad connected to another end of said signal vias; and
an artificial medium disposed between said signal via and said ground vias;
wherein said multilayer substrate comprises a plurality of conductor layers isolated by a dielectric material;
wherein said artificial medium is formed by conductor plates connected to said signal via and isolated from ground conductors by isolating slits,
and conductor plates which are connected to ground vias and isolated from said signal via by clearance holes;
wherein said artificial medium has an effective relative permittivity variation in the direction perpendicular to the surface of said multilayer substrate; and
wherein said artificial medium in four edged parts of said five parts has same effective relative permittivity, while said artificial medium in the center part of said five parts is different from said four edged parts.

8. The wideband antenna radiating element according to claim 7, wherein said coupled area comprises a slit providing an additional link between said four edge parts.

9. The wideband antenna radiating element according to claim 7, wherein said coupled area comprises a coupled strip structure providing an additional link between said four edge parts.

10. (canceled)

11. The wideband antenna radiating element according to claim 1, wherein said plurality of parts is two parts or three parts.
